(19) United States
(12) Patent Application Publication
(10) Pub. No.: US 2021/0383223 A1
(43) Pub. Date: Dec. 9, 2021

(54) Joint Architecture And Hyper-Parameter Search For Machine Learning Models

(71) Applicant: Google LLC, Mountain View, CA (US)

(72) Inventors: Mingxing Tan, Newark, CA (US); Xuanyi Dong, Sunnyvale, CA (US); Wei Yu, Palo Alto, CA (US); Quoc V. Le, Sunnyvale, CA (US); Daiyi Peng, Cupertino, CA (US)

(21) Appl. No.: 17/337,834

(22) Filed: Jun. 3, 2021

Related U.S. Application Data
(60) Provisional application No. 63/034,231, filed on Jun. 3, 2020.

(51) Int. Cl. G06N 3/08; G06N 3/04

(52) U.S. Cl. CPC G06N 3/08; G06N 3/04

(57) ABSTRACT

The present disclosure provides a differentiable joint hyper-parameter and architecture search approach, with some implementations including the idea of discretizing the continuous space into a linear combination of multiple categorical basis. One example element of the proposed approach is the use of weight sharing across all architecture- and hyper-parameters which enables it to search efficiently over the large joint search space. Experimental results on MobileNet/ResNet/EfficientNet/BERT show that the proposed systems significantly improve the accuracy by up to 2% on ImageNet and the F1 by up to 0.4 on SQuAD, with search cost comparable to training a single model. Compared to other AutoML methods, such as random search or Bayesian method, the proposed techniques can achieve better accuracy with 10× less compute cost.

### RELATED APPLICATIONS

This application claims priority to and the benefit of U.S. Provisional Patent Application No. 63/034,231, filed Jun. 3, 2020, which is hereby incorporated by reference in its entirety.

### FIELD

The present disclosure relates generally to machine learning architectures and hyper-parameters. More particularly, the present disclosure relates to systems and methods to perform joint architecture and hyper-parameter search for machine learning models.

### BACKGROUND

Neural Architecture Search (NAS) has brought significant improvements in many applications, such as machine perception, language modeling, and model compression. Most NAS approaches apply the same hyper-parameters while searching for network architectures. For example, each searched model is trained using the same optimizer, learning rate, and weight decay. As a result, the relative ranking of models in the search space is only determined by their architecture.

However, different networks actually favor their own hyper-parameters. For example, a first model may outperform a second model when each model is trained using a first set of hyper-parameter values; but the second model may outperform the first model when each model is trained with a second set of hyper-parameter values. This suggests that using fixed hyper-parameters in NAS search leads to sub-optimal results.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform joint architecture and hyper-parameter search for machine learning models. The method can include performing, by a computing system comprising one or more computing devices, one or more first search iterations and one or more second search iterations. Performing each of the one or more first search iterations can include: evaluating, by the computing system, a training loss for a first combined model having a first set of shared weight values, wherein the first combined model comprises a combination of a plurality of first sub-models that have a plurality of different architectures that are controlled by an architecture encoding; and updating, by the computing system, the first set of shared weight values based at least in part on the training loss evaluated for the first combined model. Performing each of the one or more second search iterations can include: generating, by the computing system and from the first combined model, a plurality of second sub-models respectively according to a plurality of basis sets of hyper-parameter values; combining, by the computing system, the plurality of second sub-models according to a hyper-parameter encoding to generate a second combined model having a second set of shared weight values, wherein the hyper-parameter encoding controls one or more hyper-parameters; evaluating, by the computing system, a validation loss for the second combined model; and updating, by the computing system, one or both of the architecture encoding and the hyper-parameter encoding based at least in part on the validation loss. After performing the one or more first search iterations and the one or more second search iterations, the method can include applying, by the computing system, the architecture encoding and the hyper-parameter encoding to output an output model.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example process for performing joint architecture and hyper-parameter search for machine learning models according to example embodiments of the present disclosure.

FIG. 2A depicts a block diagram of an example computing system that performs a joint architecture and hyper-parameter search according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods to perform joint architecture and hyper-parameter search for machine learning models. This joint approach enables the searched models to be coupled with their own best hyper-parameters, thus achieving better performance than existing NAS with fixed hyper-parameters. Thus, the present disclosure extends NAS to a broader and more practical space combining joint hyper-parameter and architecture optimization, resulting in improved model performance and, compared to existing architecture and hyper-parameter search techniques, faster searching with reduced computational requirements.

However, jointly searching for architectures and hyper-parameters is challenging. A first challenge is how to deal with both categorical and continuous values in the joint search space: while architecture choices are mostly categorical values (such as different convolutional kernel sizes: 3×3 and 5×5), hyper-parameters can be both categorical (such as the type of optimizer) and continuous values (such as weight decay). Furthermore, the learning rate is even more complex as it can take on a different continuous value at each training step. While previous NAS approaches only focus on the categorical search space, existing hyper-parameter optimization methods only focus on the continuous search space. They cannot be directly applied to such a mixture of categorical and continuous search space. Not surprisingly, another critical challenge is how to efficiently search over the much larger HAS search space as it combines both architecture choices and hyper-parameter choices.

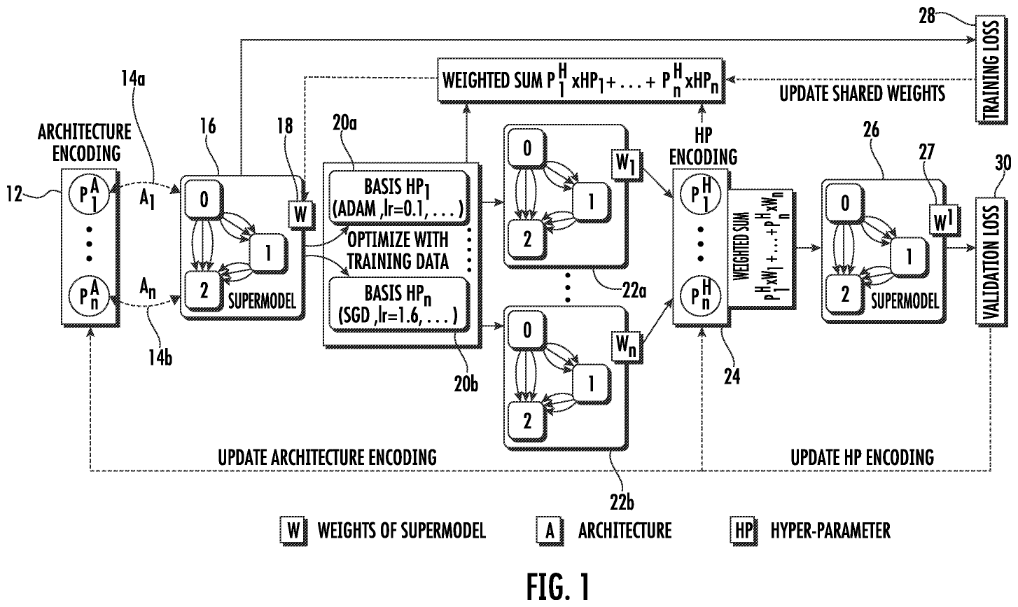

To resolve these issues, the present disclosure provides a differentiable hyper-parameter and architecture search algorithm which, in some cases, may be referred to as “AutoHAS.” The proposed systems are able to efficiently handle a joint and large HAS search space. According to one aspect, example implementations of the proposed approach unify both continuous and categorical choices to be a linear combination of multiple categorical basis. During searching, the proposed algorithm can optimize the coefficients of this linear combination (i.e., architecture and HP encoding in FIG. 1) in a differentiable way. These encodings represent the probability distribution over all candidates in the respective space. They can be used to find the best searched architecture together with its associated hyper-parameters.

In order to efficiently navigate the much larger search space, the present disclosure further introduce a novel weight sharing technique. Weight-sharing can be used to reduce the search cost. A primary idea behind weight-sharing is to train a combined model, which may also be referred to as a “SuperModel,” where each candidate in the architecture space is a sub-model of the combined model. This approach enables the search to avoid training millions of candidates from scratch.

The present disclosure extends the scope of weight-sharing from architecture search to both architecture and hyper-parameter search. Thus, the proposed systems and methods not only share the weights of the SuperModel with each architecture but also share this SuperModel across different hyper-parameters. At each searching step, the proposed algorithm can optimize the shared SuperModel by a combination of the basis of the hyper-parameter search space, and this shared SuperModel can then serve as a good initialization for all hyper-parameters at the next step.

The systems and methods described herein are applicable to various different types of hyper-parameters, such as data augmentation, training objective functions, optimizer, and learning rate.

U.S. Provisional Patent Application No. 63/034,231 contains a summary of example experimental results in which the proposed techniques outperform many AutoML methods regarding both accuracy and efficiency. For example, in experiments, the proposed techniques improve a variety of computer vision and natural language processing models, i.e., MobileNet-V2, ResNet, EfficientNet, and BERT.

The systems and methods described herein provide a number of technical effects and benefits. As one example, by jointly search architecture parameters and hyper-parameters, the systems and methods of the present disclosure are able to search for improved models much faster and using much fewer computing resources (e.g., less processing power, less memory usage, less power consumption, etc.), as compared to, for example, naive search techniques which separately search an architecture space and, separately, a hyper-parameter space. Furthermore, by extending weight-sharing to both the architectural and hyper-parameter search spaces, the proposed techniques enable searching across each of these spaces in a computationally efficient manner. Likewise, by formulating the search problem in a differentiable manner, more efficient searches can be conducted versus, for example, random search-based techniques.

As another example technical effect and benefit, the search technique described herein can automatically find significantly better models than existing approaches, which optimize over only a single search space. Furthermore, the proposed techniques represent the hyper-parameters and architectures in a unified way which can handle a mixture of categorical and continuous values of the search space.

With reference now to the Figures, example embodiments of the present disclosure will be discussed in further detail.

### Example Joint Architecture and Hyper-Parameter Search Technique

FIG. 1 shows an example framework for performing a joint architecture and hyper-parameter search. In particular, an architecture encoding (P₁^{A}, . . . , Pₙ^{A}) 12 and hyper-parameter (HP) encoding (P₁^{H}, . . . , Pₙ^{H}) 24 can represent the distribution of different choices. For example, in some implementations, the architecture encoding 12 can include a plurality of first coefficients respectively for a plurality of architectural parameters. A first combined model 16 can be generated based on a first linear combination of the plurality of first coefficients included in the architecture encoding 12.

Similarly, in some implementations, the hyper-parameter encoding 24 can include a plurality of second coefficients respectively for a plurality of hyper-parameters. A second combined model 26 can be generated based on a second linear combination of the plurality of second coefficients included in the hyper-parameter encoding 24.

More particularly, a “combined model”, which also can be referred to as a “SuperModel” (shown at 16 and 26) can share the weights among a plurality of architecture any hyper-parameter candidates.

In some implementations, the search system can alternate between updating a set of shared weights W 18 and updating the encodings (Pᵢ^{A} and Pᵢ^{H}) 12 and 24. Thus, the proposed systems and methods can include performing one or more first search iterations to update the shared weights 18 and one or more second search iterations to update the encodings 12 and 24. For example, the proposed systems and methods can alternate back and forth between the two search types.

In particular, in some implementations, performing each of the one or more first search iterations to update the shared weights 18 can include evaluating a training loss 28 for the first combined model 16 having the first set of shared weight values 18. The first combined model 16 can be a combination of a plurality of first sub-models 14a-b that have a plurality of different architectures that are controlled by the architecture encoding 12. As one example, the one or more architectural parameters can include at least a convolutional kernel size (e.g., 3×3 vs. 5×5).

Each first search iteration can further include updating the first set of shared weight values 18 based at least in part on the training loss 28 evaluated for the first combined model 16. For example, the first set of shared weight values 18 can be updated based at least in part on the training loss 28 evaluated for the first combined model 16 in according with the hyper-parameter encoding 24.

Thus, in some implementations, when updating the shared weights 18, the combined model 16 can first be run (e.g., a forward pass) to compute the training loss 28. Then, different HP basis 20a-b can be weighted by the HP encoding 24 to compute one set of hyper-parameters, which can be used to back-propagate gradients from the training loss 28 to update the shared weights W 18.

In some implementations, performing each of the one or more second search iterations can include generating, from the first combined model 16, a plurality of second sub-models 22a-b respectively according to a plurality of basis sets of hyper-parameter values 20a-b. For example, generating the second sub-models 22a-b can include separately training, by the computing system, the first combined model 16 according to each of the plurality of basis sets of hyper-parameter values 20a-b to generate the plurality of second sub-models 22a-b. In one example, separately training the first combined model 16 to generate the plurality of second sub-models 22a-b can include performing, for each basis set of hyper-parameter values 20a-b, only a single step of a gradient descent technique on the first combined model 16. This can keep training costs lower.

Next, the search system can combine the plurality of second sub-models 22a-b according to the hyper-parameter encoding 24 to generate the second combined model 26 having a second set of shared weight values 27. In particular, the hyper-parameter encoding controls one or more hyper-parameters. As examples, the one or more hyper-parameters can be: data augmentation strategy, training objective function, optimizer type, learning rate, and/or weight decay.

The search system can evaluate a validation loss 30 for the second combined model 26 and can update one or both of the architecture encoding 12 and the hyper-parameter encoding 24 based at least in part on the validation loss 30.

Thus, in some implementations, when updating the encodings 12 and 24, each HP basis combination 20a-b will result in a separate copy of the model weights (W₁, . . . , Wₙ) 22a-b. These copies 22a-b can be weighted by the HP encoding 24 to compute the final weights W′ 27. The encodings 12 and 24 can be updated by back-propagation to minimize a validation loss 30.

After this searching procedure, the final architecture and hyper-parameters can be derived from the learned architecture encoding 12 and HP encoding 24.

As one example, in some implementations, applying the architecture encoding and the hyper-parameter encoding to output an output model can include applying one or more constraints to the architecture encoding or the hyper-parameter encoding. For example, in some implementations, at least one of the architecture parameters can be a categorical value and at least one of the one or more hyper-parameters can be a continuous value. For example, in some instances, at least one of the one or more hyper-parameters can be a categorical value and at least one of the one or more hyper-parameters can be a continuous value. The output model can be a final model that is deployed, or the output model can undergo further training before deployment.

In some implementations, to account for categorical values, applying the one or more constraints can include selecting, for at least one architectural parameter or at least hyper-parameter that is categorical in nature, a single candidate value that has a highest probability out of a plurality of candidate values.

In some implementations, to account for continuous values, applying the one or more constraints can include combining, for at least one architectural parameter or at least hyper-parameter that is continuous in nature, a plurality of candidate values according to a weighted sum of their probabilities.

In some implementations, the search scheme performed in FIG. 1 can be performed iteratively. The iterative loop can stop when one or more stopping criteria are met. The stopping criteria can be any number of different criteria including as examples, a loop counter reaching a predefined maximum, iteration over iteration change in parameter adjustments falling below a threshold, the gradient of the loss 28 or loss 30 being below a threshold value, and/or various other criteria.

### Example Joint Architecture and Hyper-Parameter Search Systems

Example implementations of the present disclosure which may be referred to as AutoHAS can handle the general case of NAS and hyper-parameter optimization (HPO)—able to find both architecture α and hyperparameters h that achieve high performance on the validation set [symbol] ᵥₐₗ. This objective can be formulated as a bi-level optimization problem:

$${min}_{α , h} ℒ ( α , {ω}_{α , h}^{*} , {𝒟}_{v a l} ) s . t . {ω}_{α , h}^{*} = {f}_{h} ( α , {𝒟}_{train} ) , \qquad ( 1 )$$

where [symbol] is the objective function (e.g., cross-entropy loss). [symbol] ₜᵣₐᵢₙ and [symbol] ᵥₐₗ denote the training data and the validation data, respectively. fₕ represents the algorithm with hyperparameters h to obtain the optimal weights ω_{α,h}*. For example, fₕ could be using SGD to minimize the training loss, where h denotes the hyperparameters of SGD. In this case, ω_{α,h}* is the final optimized weights after the SGD converged.

Example implementations of the present disclosure generalize both NAS and HPO by introducing a broader search space. On the one hand, NAS is a special case of HAS, where h is fixed in Eq. (1). On the other hand, HPO is a special case of HAS, where α is fixed in Eq. (1).

### Example Unified Representation of Hyperparameters and Architectures

The search space in some example implementations is a Cartesian product of the architecture and hyperparameter candidates. To search over this mixed search space, we need a unified representation of different searchable components, i.e., architectures, learning rates, optimizer, etc.

Example Architectures Search Space

This section uses the simplest case as an example for simplified illustration. First of all, let the set of predefined candidate operations (e.g., 3×3 convolution, pooling, etc.) be [symbol] ={O₁, O₂, . . . , Oₙ}, where the cardinality of [symbol] is n for each layer in the architecture. Suppose an architecture is constructed by stacking multiple layers, each layer takes a tensor F as input and output π(F), which serves as the next layer's input. π∈ [symbol] denotes the operation at a layer and might be different at different layers. Then a candidate architecture α is essentially the sequence for all layers {π}. Further, a layer can be represented as a linear combination of the operations in [symbol] as follows:

π(F)Σᵢ₌₁ⁿCᵢ^{α}Oᵢ(F)s.t.Σᵢ₌₁ⁿCᵢ^{α}=1,Cᵢ^{α}∈{0,1}, (2)

where Cᵢ^{α} (the i-th element of the vector C^{α}) is the coefficient of operation Oᵢ for a layer.

Example Hyperparameter Search Space

This section can now define the hyperparameter search space in a similar way. The major difference is that we have to consider both categorical and continuous cases:

$$h = {\sum }_{i = 1}^{m} {C}_{i}^{h} {ℬ}_{i} s . t . {\sum }_{i = 1}^{m} {C}_{i}^{h} = 1 , \\ and \\ {C}_{i}^{h} ∈ ( \begin{matrix}[ 0 , 1 ] , if continuous \\ \{ 0 , 1 \} , if categorical\end{matrix} , \qquad ( 3 )$$

where [symbol] is a predefined set of hyperparameter basis with the cardinality of m and [symbol] ᵢ is the i-th basis in. Cᵢ^{h} (the i-th element of the vector C^{h}) is the coefficient of hyperparameter basis [symbol] ᵢ. If we have a continuous hyperparameter, we can discretize it into a linear combination of basis and unify both categorical and continuous. For example, for weight decay, [symbol] could be {1e-1, 1e-2, 1e-3}, and therefore, all possible weight decay values can be represented as a linear combination over [symbol] . For categorical hyperparameters, taking the optimizer as an example, [symbol] could be {Adam, SGD, RMSProp}. In this case, a constraint on Cᵢ^{h} is applied: Cᵢ^{h}∈{0,1} as in Eq. (3).

Example Efficient Hyperparameter and Architecture Search

Given the discretizing strategy described above, each candidate in the search space can be represented by the value of [symbol] ={C^{α} for all layers, C^{h} for all hyperparameters}, which represents the coefficients for all architecture and hyperparameter choices. As a result, example implementations of the present disclosure convert the searching problem to obtaining the coefficients [symbol] .

Some example implementations of the present disclosure can apply reinforcement learning together with weight sharing to search over the discretized space. During search, example implementations can learn a controller to sample the candidate architecture and hyperparameters from the discretized space. In example implementations, this controller can be parameterized by a collection of independent multinomial variables [symbol] ={P^{α} for all layers, P^{h} for all hyperparameters}, which draws the probability distribution of the discretized space. AutoHAS also leverages a super model to share weights [symbol] among all candidate architectures, where each candidate is a sub-model in this super model. Furthermore, example implementations can extend the scope of weight sharing from architecture to hyperparameters, where [symbol] also serves as the initialization for the algorithm fₕ.

Some example implementations of the present disclosure can alternate between learning the shared weights [symbol] and learning the controller using REINFORCE. Specifically, at each iteration, the controller samples a candidate—an architecture α and basis hyperparameter h∈ [symbol] . Its quality Q(α, h) can be estimated by utilizing the temporary weights [symbol] _{α}*, which are generated by applying the gradients from training loss to the original weights [symbol] _{α} of the architecture α with hyperparameters h. This estimated quality is used as a reward to update the controller's parameters [symbol] via REINFORCE. Then, the shared weights [symbol] can be optimized by minimizing the training loss calculated by the sampled architecture.

In practice, the training of shared weights in efficient NAS often suffers from the instability problem, and that for HAS can be more pronounced. To make the search more stable, example implementations can sample tens of candidate pairs of α and h, and average the gradients from all these pairs for [symbol] as well as that for [symbol] to update [symbol] and [symbol] . In this way, the high variance of the gradients from different samples can be significantly reduced. This strategy can be achieved via training on the distribution system, such that each core can individually sample a different pair.

During the aforementioned strategy, the temporary weights allows the process to effectively decouple the shared network weights and controller optimization. If we directly override [symbol] without using temporary weights [symbol] *, it will pollute the shared weights update. This is because that different sampled pairs will use different weights for overriding and quarrel with each other.

Example Derivation of Hyperparameters and Architecture

After some example implementations learn [symbol] ={P^{α}, P^{h}}, the process can continue by deriving the coefficient [symbol] as follows:

$${C}^{α} = o n {e}_{h o t ( {arg max}_{i} {P}^{α} )} {C}^{h} = ( \begin{matrix}{P}^{h} if continuous \\ on {e}_{h o t ( {arg max}_{i} {P}^{h} )} if categorical\end{matrix} , - 2 mm \qquad ( 4 )$$

Together with Eqs. (2) and (3), one can derive the final architecture α and hyperparameters h. Intuitively speaking, the selected operation in the final architecture has the highest probability over other candidates, and so does the categorical hyperparameter. For the continuous hyperparameter, the final one can be the weighted sum of the learnt probability P^{h} with its basis [symbol] .

To evaluate whether the search process-discovered α and h is good or not, one can use h to re-train α on the whole training set and report its performance on the test sets.

### Example Devices and Systems

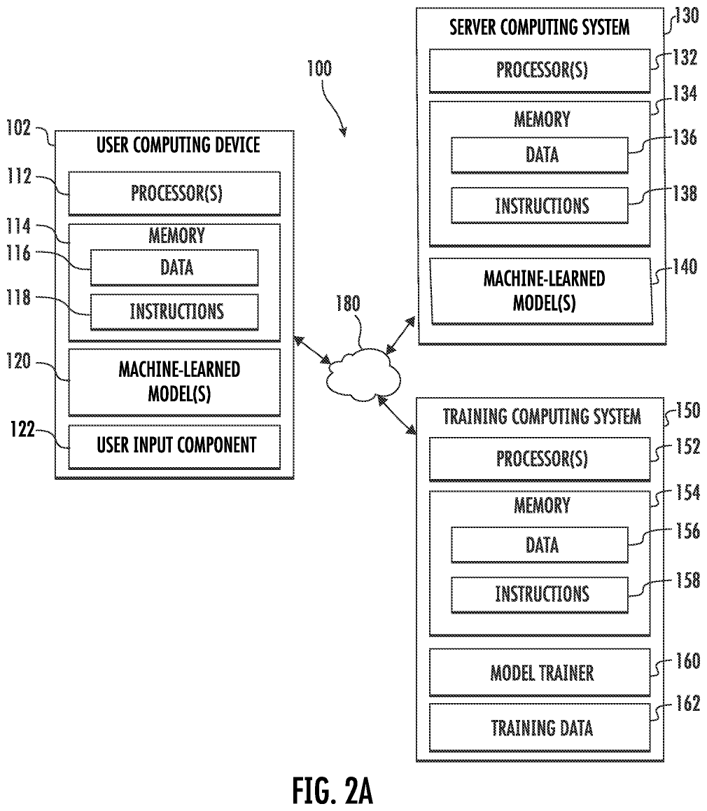

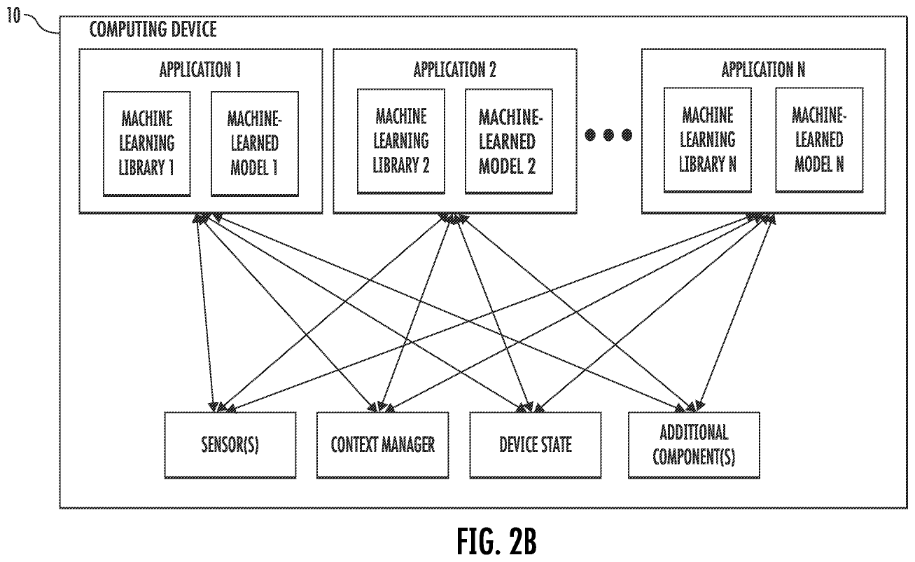

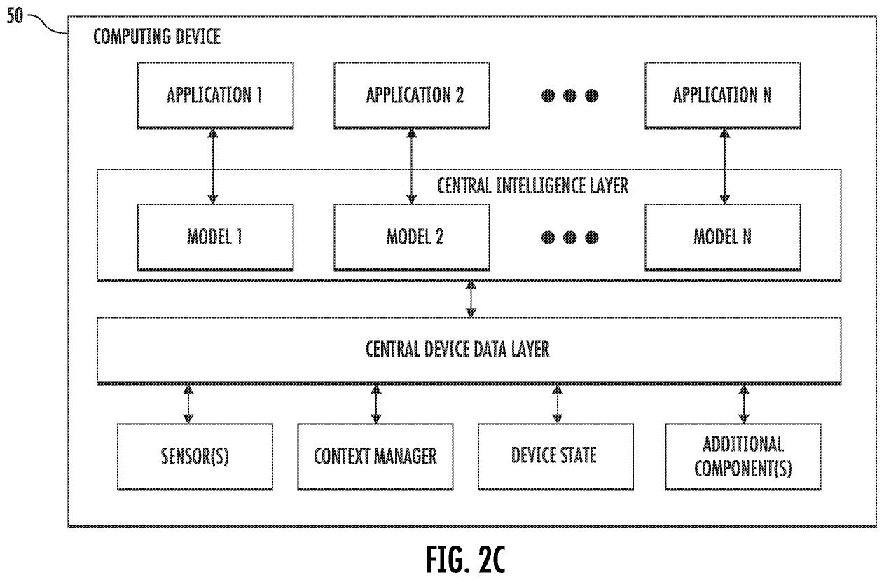

FIG. 2A depicts a block diagram of an example computing system 100 that trains and deploys machine learning models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a model search service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can be image data, audio data, textual data, and/or other modalities of data.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM hard disk or optical or magnetic media. The model trainer 160 can be configured to implement the search scheme illustrated in and discussed with reference to FIG. 1.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to perform joint architecture and hyper-parameter search for machine learning models, the method comprising:
performing, by a computing system comprising one or more computing devices, one or more first search iterations and one or more second search iterations;
wherein performing each of the one or more first search iterations comprises:
evaluating, by the computing system, a training loss for a first combined model having a first set of shared weight values, wherein the first combined model comprises a combination of a plurality of first sub-models that have a plurality of different architectures that are controlled by an architecture encoding; and
updating, by the computing system, the first set of shared weight values based at least in part on the training loss evaluated for the first combined model;
wherein performing each of the one or more second search iterations comprises:
generating, by the computing system and from the first combined model, a plurality of second sub-models respectively according to a plurality of basis sets of hyper-parameter values;
combining, by the computing system, the plurality of second sub-models according to a hyper-parameter encoding to generate a second combined model having a second set of shared weight values, wherein the hyper-parameter encoding controls one or more hyper-parameters;
evaluating, by the computing system, a validation loss for the second combined model; and
updating, by the computing system, one or both of the architecture encoding and the hyper-parameter encoding based at least in part on the validation loss; and
after performing the one or more first search iterations and the one or more second search iterations, applying, by the computing system, the architecture encoding and the hyper-parameter encoding to output an output model.

2. The computer-implemented method of claim 1, wherein performing the one or more first search iterations and the one or more second search iterations comprises alternating, by the computing system, between performance of one of the first search iterations and one of the second search iterations.

3. The computer-implemented method of claim 1, wherein updating, by the computing system, one or both of the architecture encoding and the hyper-parameter encoding based at least in part on the validation loss comprises updating, by the computing system, both the architecture encoding and the hyper-parameter encoding based at least in part on the validation loss.

4. The computer-implemented method of claim 1, wherein updating, by the computing system, the first set of shared weight values based at least in part on the training loss evaluated for the first combined model comprises updating, by the computing system, the first set of shared weight values based at least in part on the training loss evaluated for the first combined model and according to the hyper-parameter encoding.

5. The computer-implemented method of claim 1, wherein the architecture encoding comprises a plurality of first coefficients respectively for a plurality of architectural parameters, and wherein the first combined model is generated based on a first linear combination of the plurality of first coefficients.

6. The computer-implemented method of claim 1, wherein the hyper-parameter encoding comprises a plurality of second coefficients respectively for a plurality of hyper-parameters, and wherein the second combined model is generated based on a second linear combination of the plurality of second coefficients.

7. The computer-implemented method of claim 1, wherein at least one of the architectures comprises a categorical value and, wherein at least one of the one or more hyper-parameters comprises a continuous value.

8. The computer-implemented method of claim 1, wherein at least one of the one or more hyper-parameters comprises a categorical value and at least one of the one or more hyper-parameters comprises a continuous value.

9. The computer-implemented method of claim 1, wherein generating, by the computing system and from the first combined model, a plurality of second sub-models respectively according to a plurality of basis sets of hyper-parameter values comprises separately training, by the computing system, the first combined model according to each of the plurality of basis sets of hyper-parameter values to generate the plurality of second sub-models.

10. The computer-implemented method of claim 9, wherein separately training, by the computing system, the first combined model according to each of the plurality of basis sets of hyper-parameter values to generate the plurality of second sub-models comprises performing, by the computing system for each basis set of hyper-parameter values, a single step of a gradient descent technique on the first combined model.

11. The computer-implemented method of claim 1, wherein applying, by the computing system, the architecture encoding and the hyper-parameter encoding to output the output model comprises applying, by the computing system, one or more constraints to the architecture encoding or the hyper-parameter encoding.

12. The computer-implemented method of claim 11, wherein applying, by the computing system, one or more constraints to the architecture encoding or the hyper-parameter encoding comprises selecting, for at least one architectural parameter or at least hyper-parameter that is categorical in nature, a single candidate value that has a highest probability out of a plurality of candidate values.

13. The computer-implemented method of claim 11, wherein applying, by the computing system, one or more constraints to the architecture encoding or the hyper-parameter encoding comprises combining, for at least one architectural parameter or at least hyper-parameter that is continuous in nature, a plurality of candidate values according to a weighted sum of their probabilities.

14. The computer-implemented method of claim 1, wherein the one or more hyper-parameters comprise: data augmentation strategy, training objective function, optimizer type, learning rate, and/or weight decay.

15. The computer-implemented method of claim 1, wherein the architecture encoding controls one or more architectural parameters of the plurality of different architectures, wherein the one or more architectural parameters comprise at least a convolutional kernel size.

16. A computing system comprising:
one or more processors; and
one or more non-transitory computer-readable media that store instructions for performing the operations, the operations comprising:
performing one or more first search iterations and one or more second search iterations;
wherein performing each of the one or more first search iterations comprises:
evaluating a training loss for a first combined model having a first set of shared weight values, wherein the first combined model comprises a combination of a plurality of first sub-models that have a plurality of different architectures that are controlled by an architecture encoding; and
updating the first set of shared weight values based at least in part on the training loss evaluated for the first combined model;
wherein performing each of the one or more second search iterations comprises:
generating, from the first combined model, a plurality of second sub-models respectively according to a plurality of basis sets of hyper-parameter values;
combining the plurality of second sub-models according to a hyper-parameter encoding to generate a second combined model having a second set of shared weight values, wherein the hyper-parameter encoding controls one or more hyper-parameters;
evaluating a validation loss for the second combined model; and
updating one or both of the architecture encoding and the hyper-parameter encoding based at least in part on the validation loss; and
after performing the one or more first search iterations and the one or more second search iterations, applying the architecture encoding and the hyper-parameter encoding to output an output model.

17. The computing system of claim 16, wherein performing the one or more first search iterations and the one or more second search iterations comprises alternating between performance of one of the first search iterations and one of the second search iterations.

18. The computing system of claim 16, wherein updating one or both of the architecture encoding and the hyper-parameter encoding based at least in part on the validation loss comprises updating both the architecture encoding and the hyper-parameter encoding based at least in part on the validation loss.

19. The computing system of claim 16, wherein updating the first set of shared weight values based at least in part on the training loss evaluated for the first combined model comprises updating the first set of shared weight values based at least in part on the training loss evaluated for the first combined model and according to the hyper-parameter encoding.

20. One or more non-transitory computer-readable media that store:
an output model generated by performance of operations, the operations comprising:
performing one or more first search iterations and one or more second search iterations;
wherein performing each of the one or more first search iterations comprises:
evaluating a training loss for a first combined model having a first set of shared weight values, wherein the first combined model comprises a combination of a plurality of first sub-models that have a plurality of different architectures that are controlled by an architecture encoding; and
updating the first set of shared weight values based at least in part on the training loss evaluated for the first combined model;
wherein performing each of the one or more second search iterations comprises:
generating, from the first combined model, a plurality of second sub-models respectively according to a plurality of basis sets of hyper-parameter values;
combining the plurality of second sub-models according to a hyper-parameter encoding to generate a second combined model having a second set of shared weight values, wherein the hyper-parameter encoding controls one or more hyper-parameters;
evaluating a validation loss for the second combined model; and
updating one or both of the architecture encoding and the hyper-parameter encoding based at least in part on the validation loss; and
after performing the one or more first search iterations and the one or more second search iterations, applying the architecture encoding and the hyper-parameter encoding to output the output model.
